(19) United States
(12) Patent Application Publication
(10) Pub. No.: US 2011/0281236 A1
(43) Pub. Date: Nov. 17, 2011

(54) Dental implant system and method of placement

(76) Inventor: Dorel Onea, Rocklin, CA (US)

(21) Appl. No.: 12/717,118

(22) Filed: May 17, 2010

(51) Int. Cl. A61C 8/00

(52) U.S. Cl. 433/174; 433/173

(57) ABSTRACT

This new system includes a dental implant that has a cylindrical shape for most of its length, ending in a tapered apical portion. The cylindrical portion of the dental implant is divided in two areas, one that is rougher and threaded, and one that is smoother and not threaded. The non-threaded cylindrical portion at the coronal end of the dental implant is much more extended than in other dental implant systems, to ensure placement of threads under the bone level even when placed in bone that has irregular anatomy or a narrow crest. The non-threaded portion has a minimally modified surface that is compatible with placement under or above bone level, or under or above gingival level. The cylindrical shape of this portion ensures that the margin of the crown can always be extended to the gingival margin, and not only to a fixed “shoulder” area.

### FIELD OF THE INVENTION

This invention is related to the field surgical replacement of missing teeth with dental implants.

### BACKGROUND

When dental implants that are in use today are placed in less than ideal situations, the main reason for long term failure is peri-implantitis caused by exposed dental implant threads. The threads of dental implants, while they are important in the initial stabilization of dental implants, when exposed above the bone level they become a trap for bacterial plaque causing severe inflammation, bone loss and failure of the dental implant. In addition, there are multiple dental implant systems on the market that add “microthreads” to the design of the dental implant, hoping that this architecture will result in a better adaptation of bone or gingival tissue around the dental implant. This kind of mechanical engineering ignores long term evidence that tissues around natural teeth are healthier when irregular and rough root surfaces are scaled smooth.

### SUMMARY OF THE INVENTION

The present invention provides a dental implant system (dental implant 101) that improves the long term health of tissues surrounding the dental implant by minimizing the likelihood of dental implant threads being exposed above the bone level at the time of dental implant placement, or later, following minimal long term bone loss. This is accomplished by the incorporation in the design of the dental implant of an extended non-threaded section that is compatible with placement under or above bone level, and under or above gingival level. This compatibility is ensured by the minimal roughness present on the surface of the non-threaded section of the dental implant.

The cylindrical shape of the extended non-threaded portion of the dental implant 101 allows the crown restoration's margin to be placed on the body of the dental implant, beyond the dental implant abutment, at or under the margin of the gingiva, as allowed by the biologic width.

The cylindrical shape of the extended non-threaded portion of the dental implant 101 allows the crown restoration's margin to be placed and tapered on the body of the dental implant in a way that minimizes the presence of a gap following the cementation of the crown, and it eliminates the presence of an exposed micro-gap between the abutment and the implant body.

The cylindrical shape of the extended non-threaded portion of the dental implant 101 allows the crown restoration's margin to be placed on the body of the dental implant, adding to the mechanical support and retention of the crown.

The cylindrical shape of the extended non-threaded portion of the dental implant 101 allows the crown restoration's margin to be placed on the body of the dental implant, eliminating the need to stop the restoration at the abutment level, and to leave the surface of the dental implant exposed when there is gingival recession following placement.

The cylindrical shape of the extended non-threaded portion of the dental implant 101 allows the crown restoration's margin to be placed on the body of the dental implant to create an emergence profile in a way that improves the esthetic outcome.

The extended non-threaded portion of the dental implant 101 allows placement in narrow crestal bone with increased likelihood that all threads are covered by bone following placement.

The dental implant 101 has the non-threaded portion extended up to 66% of the length of the implant, this percentage may be inversely proportional with the width of the dental implant; wide diameter dental implants will have a shorter non-threaded portion.

The extended non-threaded portion of the dental implant 101 allows placement of the dental implant in crestal bone with irregular surface anatomy with increased likelihood that all threads are covered by bone following placement.

The extended non-threaded portion of the dental implant 101 allows placement of the dental implant without surgically reflecting a gingival flap with increased likelihood that all threads are covered by bone following placement.

The cylindrical part of the threaded portion of the dental implant 101 allows partial reversal of the dental implant with minimal decrease mechanical retention and bone support.

The tapered part of the threaded portion of the dental implant 101 allows the osteotomy drills to be used in stepped sequence, eliminating the need to use the final wide drill for the entire length of the osteotomy, minimizing the risk of severe damage to adjacent teeth, sinuses, or nerves.

The intention of the present invention is to create a dental implant system that is much easier to place and restore than dental implant systems currently on the market, and has the goal of obtaining a unique balance of features that results in significantly improved long term prognosis when dental implants are placed in less than ideal situations. While most previously designed dental implant systems work well under ideal circumstances, long term failure of dental implants is still a common occurrence. The reasons why dental implants fail months or years after they were restored were carefully studied for over a decade, and were considered for this invention. The result is a dental implant system that requires a shorter operator learning curve, is less technique sensitive during placement, and is compatible with placement without surgical reflection of gingiva (flapless), when this technique is indicated.

### DESCRIPTION OF DRAWINGS

FIG. 1: Dental implant 101

FIG. 2: Dental implant 101 placed in mandibular bone with narrow ridge, threads placed under the bone level due to the extended cylindrical non-threaded portion.

FIG. 3: Crown margin may be extended as needed on the extended cylindrical non-threaded portion of the dental implant 101.

FIG. 4: Straight abutment designed for cement or for screw retention.

FIG. 5: Angled abutment designed for cement or for screw retention.

FIG. 6: Dental implant 101 cross-section.

FIG. 7: Dental implant with abutment, one-piece design.

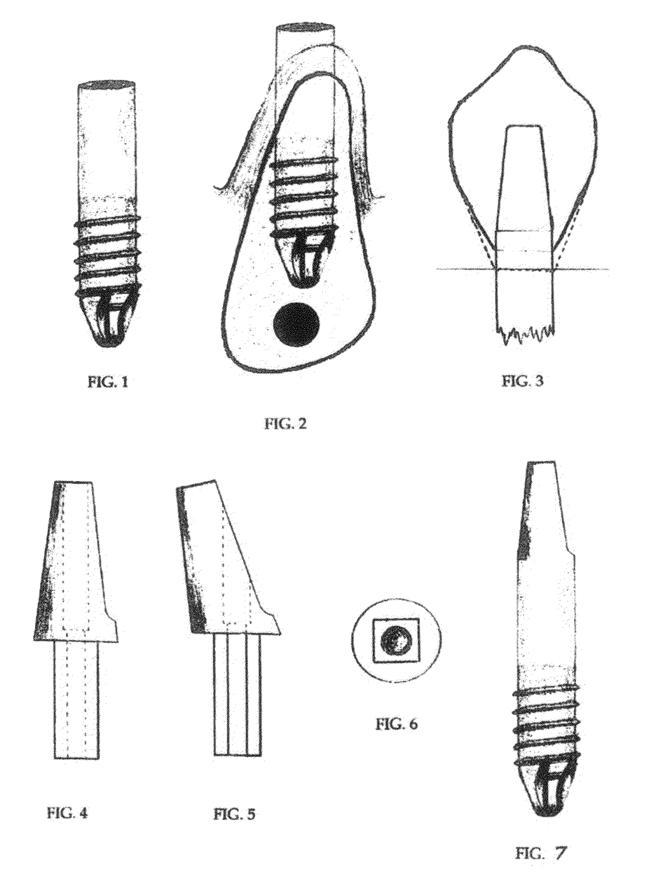

1. A dental implant (101) that has a general cylindrical shape with a short tapered section at the tip of the dental implant.

2. The cylindrical section is divided in two areas, one that threaded and one that is not threaded.

3. The dental implant described in claim 1 has the cylindrical non-threaded section extended up to two thirds of the length of the implant.

4. The dental implant described in claim 1 has minimal roughness at the surface of the cylindrical non-threaded section.

5. The dental implant described in claim 1 has significant roughness at the surface of the threaded section.

6. The tapered section described in claim 1 has cutting notches that aid self-tapping, extending at least 1 mm on the threaded cylindrical section.

7. The non-threaded cylindrical section may have an opening at the coronal end that has the shape of a right prism with polygonal ends.

8. The opening described in claim 6 may include threads that may receive a corresponding screw.

9. The opening described in claim 6 may receive an insertion tool.

10. The cylindrical section of the dental implant that remains above the bone level may be extended further to include a solid abutment that is an integral part of the dental implant.
